(19) United States
(12) Patent Application Publication
(10) Pub. No.: US 2026/0297239 A1
(43) Pub. Date: Oct. 1, 2026

(54) Method for the Production of a Thermoplastic Polyurethane Powder by Means of Precipitation Polymerisation

(71) Applicant: Covestro Deutschland AG, Leverkusen (DE)

(72) Inventors: Heiko Hocke, Leverkusen (DE); Rene Muenchrath, Köln (DE); Simon Peerenboom, Rheinberg (DE)

(21) Appl. No.: 19/480,899

(22) PCT Filed: May 2, 2024
(86) PCT No.: PCT/EP2024/062007

§ 371 Date: Nov. 3, 2025

(30) Foreign Application Priority Data
May 4, 2023 (EP) 23171532.7

(51) Int. Cl. C08G 18/08; C08G 18/32; C08G 18/72; C08G 18/73; C08G 18/76; C08G 18/82; C08J 3/205; C08K 5/00; C09D 5/03; C09D 7/48; C09D 7/63; C09D 175/04

(52) U.S. Cl. CPC C08G 18/0871; C08G 18/3206; C08G 18/722; C08G 18/73; C08G 18/7671; C08G 18/82; C08J 3/2053; C09D 5/036; C09D 7/48; C09D 7/63; C09D 175/04; C08J 2375/04; C08K 5/005

(57) ABSTRACT

A process for producing a thermoplastic polyurethane powder by precipitation polymerization includes:
i. providing
A) a solvent mixture including at least one first aprotic solvent A1) having a relative permittivity εᵣ of 3 to 20 and at least one second aprotic polar solvent A2) having a relative permittivity εᵣ of at least 24, the relative permittivity Fr being measured in each case at 20° C. and 100 kHz;
B) at least one polyol having a molar mass of between 60 g/mol and 250 g/mol; and
C) at least one diisocyanate;
ii. reacting the polyol B) with the diisocyanate C) in the solvent mixture A) at a temperature of not more than 150° C.;
iii. removing the solvent mixture and optionally washing the thermoplastic polyurethane with a solvent; and
iv. drying the thermoplastic polyurethane to give the thermoplastic polyurethane powder.

### CROSS-REFERENCE TO RELATED APPLICATIONS

This application is the United States national phase of International Patent Application No. PCT/EP2024/062007 filed May 2, 2024, and claims priority to European Patent Application No. 23171532.7 filed May 4, 2023, the disclosures of which are hereby incorporated by reference in their entireties.

### BACKGROUND

### Technical Field

The present invention relates to a process for producing a thermoplastic polyurethane powder by precipitation polymerization, to the thermoplastic polyurethane powder obtained or obtainable by this process and to the use thereof. The invention further relates to a moulding obtained or obtainable by processing the thermoplastic polyurethane powder of the invention.

### Description of Related Art

There is high interest in the production of polymer powders for use in powder sintering processes, as an additive for structured surfaces or as abrasives and lubricants in cosmetic applications and in industry. Powder sintering processes are more particularly processes in which a powder layer is first applied, which in a further step is then sintered together or the powder particles fused together. Such processes are used, for example, for coating metals, polymers, wood, fibres and other materials, where the surface is impregnated with powder by dipping in a fluidized bed, by means of a spray gun or via a dispersion, and then heated. In addition to epoxy resins and polyester resins, a diverse range of thermoplastic polymers such as polypropylene, polyamides, PVC, acrylates and polyurethanes are also used.

A process for producing thermoplastic polyurethanes (“TPU”) was described as long ago as 1937, in DE728981C. TPUs, which include in particular an HDI-BDO adduct (HDI=hexamethylene 1,6-diisocyanate; BDO=butane-1,4-diol) later marketed for some time under the names Perlon U, Igamid U and Durethan U on account of its combination of good properties such as high melting point, high elastic modulus and good chemical resistance (O. Bayer Angew. Chem. 1947, 59, 9, 257-288), are produced by reaction in a solvent (for example chlorobenzene and dioxane). The solvent is normally removed under reduced pressure. In some examples, TPUs were also precipitated as a gel or powder. It was however subsequently found that the molecular chain lengths achieved were sometimes insufficient to obtain good polymer properties. Higher-molecular weight TPU powders based on BDO-HDI, for example, are therefore not accessible in this way.

However, most polymers such as polypropylene, polyamide or thermoplastic polyurethanes that can be used, for example, for powder coatings or powder sintering processes are produced in the form of a melt. The polymer thus obtained must be brought into the powder form in a further process step, for example by grinding. In the production of, for example, aliphatic thermoplastic polyurethanes in the melt, the pure monomers, for example butane-1,4-diol (BDO) and hexamethylene 1,6-diisocyanate (HDI), are converted into an OH-terminated prepolymer in a reaction vessel. The second stage of the reaction is then carried out in a heavy-duty mixer by adding HDI (in a substoichiometric amount; index I=approx. 0.98) to the prepolymer to form the end product (B.I.O.S. Final Report No. 1472, ITEM No. 22, pp. 47-48). The disadvantages of the process include inter alia the high reaction temperature and the lengthy and also poor mixing process, which leads to an increase in unwanted side reactions. This melting process can also be carried out in a modified form. In this variant, the monomers BDO and HDI are reacted in a loop reactor or alternatively in static mixers (Fluitec reactors) to give the prepolymer, which, in a second reaction step, reacts further in a reactive extrusion with HDI to give the final polymer. However, the disadvantages of a relatively high allophanate content and the occurrence of gel particles cannot be avoided even if conversion is kept within limits (substoichiometric amount of HDI, I 0.98) (WO2021122279). In the melt processes described here as an example, the polymer is obtained in the form of pellets after reactive extrusion and must still be converted into the powder form in a further process step.

For most polymers such as polyamides (shown for example in EP3491066A1), polypropylene and the likewise frequently used thermoplastic polyurethanes (see EP3512687B1), grinding, in particular cryo grinding, is used to convert the pellets into a powder. In cryo grinding, the polymer pellets are cooled to low temperature with liquid nitrogen and then ground. The desired grain size is separated from the ground material by screening. The disadvantage of grinding processes in general is that the particle shape is not spherical, but highly irregular and angular. This adversely affects flow behaviour and the screening of the ground material is more laborious. Moreover, the particle size distribution in grinding is very broad, as a result of which the yield is low or the grinding and screening process needs to be repeated multiple times. Moreover, cryo grinding is a high-cost process, on account of the use of liquid nitrogen for adequate cooling of the polymers.

A special case is polyamide 12 (or polyamide 11), which is initially produced as PA 12 pellets and dissolved in ethanol under pressure at elevated temperature and then reprecipitated and dried under very precisely controlled conditions (see for example EP0911142B1). The advantage of this method is that the polymer powder is obtained as relatively spherical particles that additionally have a particle size of <100 μm (free-flowing) and do not need to be classified (screened). The disadvantages of the process, besides additional work steps and process equipment, include the associated costs and little or no additivation of the polymer.

The complexity of the above processes makes them costly and/or their disadvantages make them unsuitable for the production of thermoplastic polyurethane powders having long chain lengths allied with a low allophanate content, which consequently places limits on the use in industry of thermoplastic polyurethane powders and on the processes dependent thereon (powder sintering processes; filler for surface structuring).

There is therefore a need for a process for producing thermoplastic polyurethane powders having high molar masses and low allophanate contents.

### SUMMARY

The problem addressed by the present invention was accordingly that of providing a process for producing thermoplastic polyurethane powders having high molar masses and low allophanate contents. In particular, the process should result in thermoplastic polyurethane powders having a mass-average molar mass of >35 000 g/mol and an allophanate content of <0.25 mol % based on the total thermoplastic polyurethane powder. In addition, the further processing of the thermoplastic polyurethane powders should result in mouldings that are as free as possible of gel particles and/or also have good mechanical properties, in particular a good elongation at break and a good elastic modulus.

### DETAILED DESCRIPTION

The problem was solved by a process for producing a thermoplastic polyurethane powder by precipitation polymerization, comprising the steps of:
i. providing
   A) a solvent mixture comprising at least one first aprotic solvent A1) having a relative permittivity Er of 3 to 20 and at least one second aprotic polar solvent A2) having a relative permittivity Er of at least 24, the relative permittivity Er being measured in each case at 20° C. and 100 KHz;
   B) at least one polyol having a molar mass of between 60 g/mol and 250 g/mol;
   C) at least one diisocyanate;
   D) optionally a catalyst;
   E) optionally a chain regulator E1) and/or an additive E2);
ii. reacting the polyol B) with the diisocyanate C) in the solvent mixture A) at a temperature of not more than 150° C., optionally in the presence of the catalyst D), the chain regulator E1) and/or the additive E2), to give the thermoplastic polyurethane, wherein the thermoplastic polyurethane precipitates as a solid in the solvent mixture A), forming a dispersion;
iii. removing the solvent mixture and optionally washing the thermoplastic polyurethane with a solvent; and
iv. drying the thermoplastic polyurethane to give the thermoplastic polyurethane powder;
wherein the thermoplastic polyurethane powder has
   a mass-average molar mass Mw of >35 000 g/mol;
   an allophanate content of 0.25 mol % based on the total thermoplastic polyurethane powder; and
   25.0% by weight of a particle fraction of <0.500 mm, based on the total thermoplastic polyurethane powder, and/or a ratio of centrifuge-average molar mass Mz to mass-average molar mass Mw of <4.0;
wherein the mass-average molar mass Mw, the allophanate content, the particle fraction and the centrifuge-average molar mass Mz are in each case determined using the methods described further below.

In the course of the development work that led to the present invention, it was surprisingly found that the use in a precipitation polymerization of a specific solvent mixture, namely one comprising at least one first aprotic solvent A1) having a relative permittivity εᵣ of 3 to 20 and at least one second aprotic polar solvent A2) having a relative permittivity εᵣ of at least 24, the relative permittivity &r being measured in each case at 20° C. and 100 kHz, results in thermoplastic polyurethane powders having high molar masses and low allophanate contents.

The number-average molar mass (Mn), the mass-average molar mass (Mw) and the centrifuge-average molar mass (Mz) of the thermoplastic polyurethane powder are determined by gel-permeation chromatography (GPC). For this, the analysis sample is dissolved in a solution of 3 g of potassium trifluoroacetate in 400 cubic centimetres of hexafluoroisopropanol (concentration of sample approx. 2 mg/cubic centimetre). The respective GPCs are measured with the following components at a flow rate of 1 cubic centimetre/minute:
Pump: 515 HPLC pump (Waters GmbH)
Detector: Smartline 2300 RI detector (Knauer Wissenschaftliche Geräte GmbH)
Columns: 1 precolumn, 1000 Å PSS PFG 7 μm, 300 Å PSS PFG 7 μm, 100 Å PSS
PFG 7 μm in this sequence (PSS Polymer Standards Service GmbH)
Degassing: PSS degasser (PSS Polymer Standards Service GmbH)
Injected volume: 100 microlitres
Temperature: 23° C.-25° C.
Molar mass standard: Polymethylmethacrylate standard kit (PSS Polymer Standards Service GmbH)

The number-average molar mass (Mn or M̅ₙ) is calculated from the data obtained by the gel-permeation chromatography measurement using the following equation:

$${\overline{M}}_{n} = \frac{{\sum }_{i} {n}_{i} {M}_{i}}{{\sum }_{i} {n}_{i}} in g / mol$$

where:
Mᵢ is the molar mass of the polymers of fraction i, such that Mᵢ<Mᵢ₊₁ for all i, in g/mol,
nᵢ is the molar amount of the polymer of fraction i, in mol.

The mass-average molar mass (Mw or M̅_{w}) is likewise calculated from the data obtained by the gel-permeation chromatography measurement using the following equation:

$${\overline{M}}_{w} = \frac{{\sum }_{i} {n}_{i} {M}_{i}^{2}}{{\sum }_{i} {n}_{i} {M}_{i}} in g / mol$$

where:
Mᵢ is the molar mass of the polymers of fraction i, such that Mᵢ<Mᵢ₊₁ for all i, in g/mol,
nᵢ is the molar amount of the polymer of fraction i, in mol.

The centrifuge-average molar mass (Mz or M̅_{z}) is calculated from the data obtained by the gel-permeation chromatography measurement using the following equation:

$${\overline{M}}_{z} = \frac{{\sum }_{i} {n}_{i} {M}_{i}^{3}}{{\sum }_{i} {n}_{i} {M}_{i}^{2}} in g / mol$$

where:
Mᵢ is the molar mass of the polymers of fraction i, such that Mᵢ<Mᵢ₊₁ for all i, in g/mol,
nᵢ is the molar amount of the polymer of fraction i, in mol.

The allophanate content of the thermoplastic polyurethane powder is determined by 1H NMR. The measurements are carried out with a Bruker AV III HD 600 spectrometer at 600 MHz in DMSO-D6 at 80° C. The following peaks are evaluated:

| | | | | |
|---|---|---|---|---|
| U= | CH₂—NH | 2.98 | ppm | CH₂ in urethane |
| O= | CH₂—OH | 3.43 | ppm | CH₂ next to OH groups |
| N= | N—H | 6.6 | ppm | urethane |
| A= | N—H | 8.3-8.4 | ppm | allophanate |

The allophanate concentration or allophanate content in mol % is calculated using the following formula:

$$Allophanate [ mol \% ] = 100 \% * A / ( A + N )$$

The conversion index is obtained from the formula:

$$I = 1 / ( 1 + O / U )$$

For the determination of the particle fraction, an approx. 100 g amount of sample is screened for 5 min using a Haver & Boecker laboratory sieve shaker No. 7279 (build year 1978) and the corresponding screen set (e.g. 0.100 mm, 0.250 mm and 0.500 mm) and the individual fractions are then weighed.

Tensile testing (for determining the elongation at break and elastic modulus) is carried out in the context of the invention on the basis of test method DIN EN ISO 527 using type 5A test specimens (DIN EN ISO 527-2, thickness 2 mm). The test specimens are stored under standard conditions for at least 24 h prior to testing. The tensile tests are carried out at 22° C. and 50% relative humidity using a Zwick Z010 universal testing machine at a speed of 10 mm/min. The elastic modulus is determined at between 0.05% and 0.25% strain using the secant method.

It is preferable that the first aprotic solvent A1) comprises or consists of halogenated aromatics, ketones, ethers, esters and carbonates or mixtures thereof, especially chlorobenzene and/or ortho-dichlorobenzene, cyclopentanone, cyclohexanone, heptan-4-one, acetophenone or mixtures thereof, further preferably chlorobenzene, and/or the second aprotic polar solvent A2) of dimethyl sulfoxide, dimethylformamide, N-methyl-2-pyrrolidone, tetramethylurea (TMU), 1,3-dimethyl-3,4,5,6-tetrahydro-2 (1H)-pyrimidinone, 1,3-dimethyl-2-imidazolidinone, N-ethyl-2-pyrrolidone, benzonitrile, dimethylacetamide or mixtures thereof, preferably dimethyl sulfoxide.

The ratio of the first aprotic solvent A1) to the second aprotic polar solvent A2) is preferably 300:1 to 1:9, further preferably 200:1 to 1:1, even more preferably 100:1 to 8:2.

It is further preferable that the polyol B) comprises or consists of ethylene glycol, propane-1,3-diol, butane-1,4-diol, pentane-1,5-diol, neopentyl glycol, hexane-1,6-diol, octane-1,8-diol, decane-1,10-diol, dodecane-1,12-diol or mixtures thereof, wherein the polyol B) preferably comprises at least 50.0% by weight of butane-1,4-diol, more preferably at least 90.0% by weight of butane-1,4-diol, based on the total weight of polyol B).

The diisocyanate C) preferably comprises or preferably consists of butane 1,4-diisocyanate, pentane 1,5-diisocyanate, hexane 1,6-diisocyanate, isophorone diisocyanate, 1,1′-methylene bis(4-isocyanatocyclohexane) or xylylene diisocyanate, especially m-xylylene diisocyanate, or mixtures thereof, wherein the diisocyanate C) further preferably comprises at least 50.0% by weight of pentane 1,5-diisocyanate or hexane 1,6-diisocyanate, based on the total weight of the diisocyanate C).

The optional catalyst D) may be selected from, for example, typical urethanation catalysts such as those in Becker/Braun, Kunststoffhandbuch [Plastics Handbook], volume 7, Polyurethane [Polyurethanes], chapter 3.4, or mixtures thereof.

The optional chain regulator E1) may be selected for example from the group comprising or consisting of monofunctional compounds having a hydrogen atom with Zerewitinoff acidity, monofunctional isocyanates or mixtures thereof. Examples of the optional chain regulator E1) include n-octanol, benzyl alcohol, n-octylamine, dioctylamine, ¿-caprolactam, propanone oxime, butane-1-thiol, acetylacetone and diethyl malonate.

The optional additive E2) may be selected for example from the group comprising or consisting of stabilizers, dyes and markers or mixtures thereof.

Dyes are understood here as meaning organic compounds that absorb at least parts of the visible light between 380 nm and 790 nm. Particular preference is given to dyes that under the reaction conditions stated in step ii. are present in dissolved form and react with a compound having a hydrogen atom with Zerewitinoff acidity or with an isocyanate group, thereby becoming covalently attached to the thermoplastic polyurethane.

Markers are understood here as meaning compounds that are easy to detect with the aid of analytical methods and are specific. These may be for example aromatic compounds that have a specific UV absorbance or UV absorption pattern or that can be detected by fluorescence spectroscopy. Further examples of markers are isotope-enriched compounds that can be easily detected by NMR spectroscopy or through their radioactive radiation. Particular preference is given to markers that under the reaction conditions stated in step ii. are present in dissolved form and react with a compound having a hydrogen atom with Zerewitinoff acidity or with an isocyanate group, thereby becoming covalently attached to the thermoplastic polyurethane.

It is further preferable that
30.0% to 95.0% by weight, preferably 60.0% to 90.0% by weight, of the solvent mixture A);
2.0% to 40.0% by weight, preferably 3.0% to 20.0% by weight, of the polyol B);
3.0% to 40.0% by weight, preferably 5.0% to 25.0% by weight, of the diisocyanate C);
0% to 5.0% by weight, preferably 0% to 0.1% by weight, of the catalyst D);
0% to 10.0% by weight, preferably 0.001% to 1.5% by weight, of the chain regulator E1);
0% to 20.0% by weight, preferably 0.0001% to 3.0% by weight, of the additive E2);
are provided, in each case based on the total amount of solvent mixture A), polyol B), diisocyanate C), catalyst D), chain regulator E1) and additive E2), normalized to 100% by weight.

The reaction in step ii. is carried out preferably at a temperature of from 50° C. to 150° C., further preferably from 100° C. to 145° C., even more preferably from 120° C. to 140° C. and/or at an isocyanate index of from 0.95 to 1.1, further preferably from 0.97 to 1.02, even more preferably from 0.98 to 1.0. The dispersion formed in step ii. preferably has a solids content of from 5.0% to 50.0% by weight, further preferably from 15.0% to 45.0% by weight, even more preferably from 20.0% to 40.0% by weight, determined by gravimetric measurement with and without solvent.

The isocyanate index is calculated from the molar amount of the reactive isocyanate groups divided by the molar amount of the reactive groups having a hydrogen atom with Zerewitinoff acidity.

$$I = {n}_{iso} / {n}_{acidic H}$$

The reaction in step ii. can also be carried out in an autoclave at a pressure lower or higher than the ambient atmospheric pressure, for example, if solvents A1 and/or A2 have a boiling point lower than the reaction temperature at approx. 1 bar. It is preferable to carry out the reaction in step ii. at ambient pressure.

It is additionally preferable that the removal in step iii. is effected by filtration, centrifugation and/or by evaporation of the solvents. In step iii., the thermoplastic polyurethane may also additionally be washed with a solvent (optional washing). This solvent preferably comprises or consists of a solvent having a boiling point of between −30° C. and +250° C. (at 1 bar), preferably halogenated aromatics and alkanes, ketones, ethers, esters, alcohols, nitriles, water and carbonates or mixtures thereof, especially chlorobenzene, methyl ethyl ketone, acetone, a C1-C6 alcohol and esters thereof, dimethyl carbonate, diethyl carbonate and mixtures thereof, especially preferably chlorobenzene.

The drying in step iv. is further preferably carried out with movement or mixing of the dry material, especially preferably in a paddle dryer.

It is also preferable that the thermoplastic polyurethane powder has
a mass-average molar mass Mw of from 40 000 to 300 000 g/mol, preferably from 45 000 to 150 000 g/mol, more preferably from 55 000 to 100 000 g/mol;
an allophanate content of from 0 to 0.20 mol %, preferably from 0.001 to 0.15 mol %, more preferably from 0.01 to 0.10 mol %, based on the total thermoplastic polyurethane powder; and/or
from 30.0% to 100% by weight, further preferably from 40.0% to 80.0% by weight, of a particle fraction of <0.500 mm, based on the total thermoplastic polyurethane powder, and/or a ratio of centrifuge-average molar mass Mz to mass-average molar mass Mw of <3.0, preferably of from 1.5 to 2.2.

It is further preferable that the thermoplastic polyurethane powder has
a mass-average molar mass Mw of from 40 000 to 300 000 g/mol, preferably from 45 000 to 150 000 g/mol, more preferably from 55 000 to 100 000 g/mol;
an allophanate content of from 0 to 0.20 mol %, preferably from 0.001 to 0.15 mol %, more preferably from 0.01 to 0.10 mol %, based on the total thermoplastic polyurethane powder; and/or
>25.0% by weight, preferably from 40.0% to 100% by weight, further preferably from 50.0% to 95.0% by weight, of a particle fraction of <0.250 mm, based on the total thermoplastic polyurethane powder, and/or a ratio of centrifuge-average molar mass Mz to mass-average molar mass Mw of <3.0, preferably of from 1.5 to 2.2.

It is additionally preferable that the thermoplastic polyurethane powder has
a mass-average molar mass Mw of from 40 000 to 300 000 g/mol, preferably from 45 000 to 150 000 g/mol, more preferably from 55 000 to 100 000 g/mol;
an allophanate content of from 0 to 0.20 mol %, preferably from 0.001 to 0.15 mol %, more preferably from 0.01 to 0.10 mol %, based on the total thermoplastic polyurethane powder; and/or
>5.0% by weight, preferably from 15.0% to 100% by weight, further preferably from 25.0% to 95.0% by weight, of a particle fraction of <0.100 mm, based on the total thermoplastic polyurethane powder, and/or a ratio of centrifuge-average molar mass Mz to mass-average molar mass Mw of <3.0, preferably of from 1.5 to 2.2.

Depending on the choice of the powder sintering process and the use specifications for the polyurethane powder, powders having different grain sizes are used, but the grain sizes are usually within a range of up to 0.500 mm and smaller.

A further important aspect of grain size is the formation of a dispersion that is as stable as possible during the reaction and for the processing thereof. After transfer to industrial scale, the dispersion needs to be transported by means of pumps, must not sediment prematurely and should also have good filtration properties. If the grain size is too large, the particles will settle too quickly, causing deposits and increased wear on the pumps.

The thermoplastic polyurethane according to step iii, and/or the thermoplastic polyurethane powder according to step iv. may in addition be impregnated with a stabilizer from a stabilizer solution. For this, the thermoplastic polyurethane according to step iii, and/or the thermoplastic polyurethane powder according to step iv. is preferably dispersed in the stabilizer solution and then separated off and dried. The stabilizer solution preferably comprises or preferably consists of
a solvent selected from the group comprising or consisting of solvents of the group of chlorinated aromatics; aliphatics; esters; ethers; alcohols; water; ketones; nitriles; carbonates; or mixtures thereof, or preferably the solvent(s) A1) from step i., the solvent(s) preferably having a boiling point of <250° C. at 1 bar; and
a stabilizer dissolved therein selected from the group comprising or consisting of sterically hindered phenol derivatives, organic phosphine, phosphite and/or phosphonate derivatives (generally also referred to as phosphorus-based stabilizers), sulfur-containing antioxidants, 2,2,6,6-tetramethylpiperidine derivatives, benzotriazole derivatives, triazine derivatives, hydroxybenzophenone derivatives, cyanoacrylate derivatives, oxalinide derivatives or mixtures thereof;
where the proportion by weight of the stabilizer is preferably from 0.001% to 10.0% by weight, further preferably from 0.05% to 5.0% by weight, based on the total weight of the stabilizer solution.

It is preferable that the stabilizer solution comprises, as phosphorus-based stabilizers, phosphorus (III) compounds that when hot are oxidized in the presence of oxygen to phosphorus (V) compounds. Further preference is given to using organic phosphites, phosphine compounds and phosphonates, especially organic phosphites and phosphonates.

Particularly preferably, the phosphorus-based stabilizer is selected from at least one compound corresponding to the structures (1), (2), (3), (4), (5) and (6).

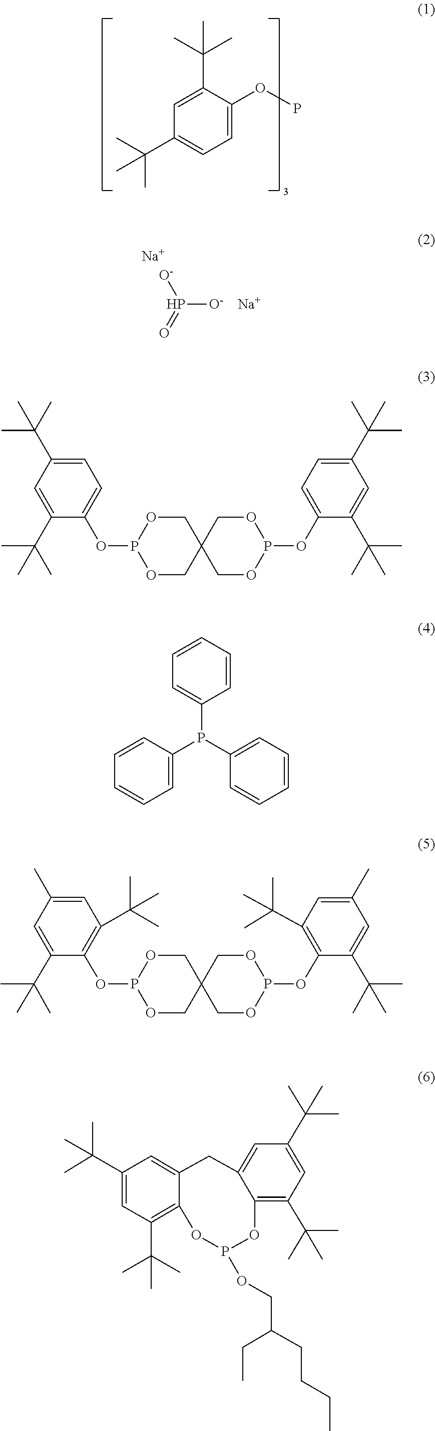

Compound (1) is classified as CAS: 31570-04-4 and is commercially available under the name Irgafos™ 168 from BASF (Germany).

Compound (2) is classified as CAS: 237-249-1 and is commercially available under the name Brüggolen™ H10 from Brüggeman (Germany).

Compound (3) is classified as CAS: 26741-53-7 and is commercially available under the name Irgafos™ 126 from BASF (Germany).

Compound (4) is classified as CAS: 603-35-0 and is commercially available under the name triphenylphosphine from BASF (Germany).

Compound (5) is classified as CAS: 80693-00-1 and is commercially available under the name ADK Stab™ PEP 36 from Adeka (Japan).

Compound (6) is classified as CAS: 126050-54-2 and is commercially available under the name ADK Stab™ HP-10 from Adeka (Japan).

A further suitable stabilizer containing phosphorus (III) is AddWorks™ LXR 568 MP from Clariant (Switzerland).

It is preferable that the phosphorus-based stabilizer is selected from the group comprising or consisting of compounds corresponding to the structures (1), (2), (4), (6) or mixtures thereof. Particularly preferred phosphorus-based stabilizers are the compounds corresponding to structures (1) and/or (2). These phosphorus-based stabilizers achieve particularly high tensile strength in the moulding produced.

The stabilizer solution may additionally comprise a sterically hindered phenol. Mixtures of two or more such components and different stabilizers may also be used.

The sterically hindered phenol is preferably a compound of the general structure (7a) or (7b)

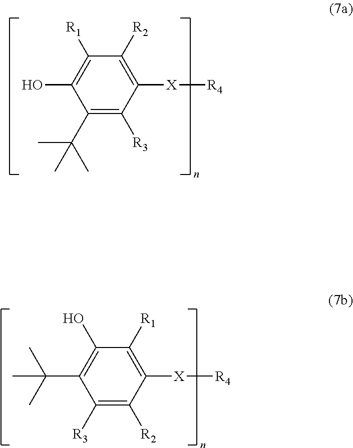

where n is 1, 2, 3 or 4,
R₁, R₂ and R₅ are each independently C₁ to C₄ alkyl or hydrogen,
X is a direct bond or a C₁ to C₆₀ organic radical and the organic radical may contain oxygen and/or nitrogen.
R₄ is a direct bond, carbon, C₁-C₈alkyl, aryl or a structure corresponding to formula (8a), (8b) or (8c).

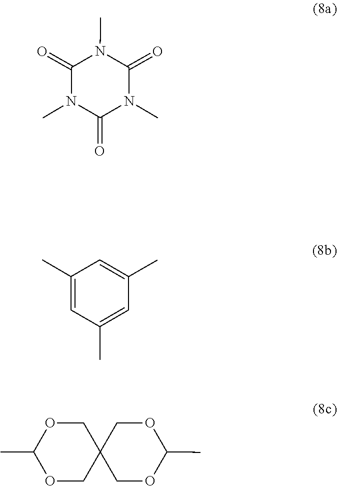

Particularly preferably, the sterically hindered phenol is selected from at least one compound corresponding to the structures (9), (10), (11) and (12).

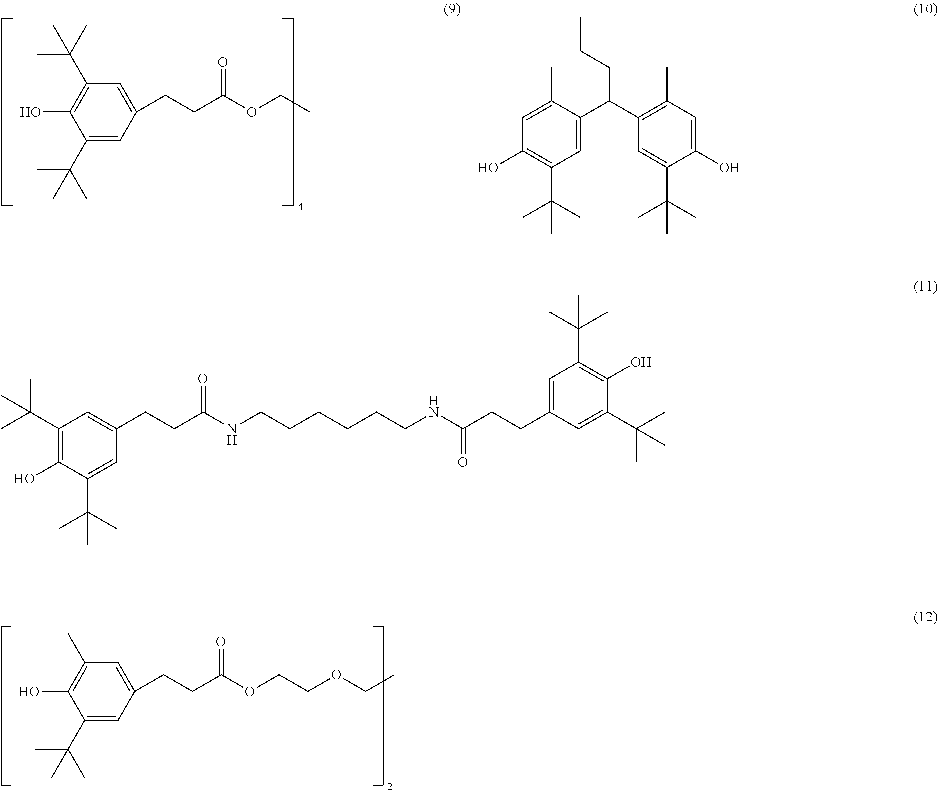

Compound (9) is classified as CAS: 6683-19-8 and is commercially available under the name ADK Stab™ AO-60 from Adeka (Japan).

Compound (10) is classified as CAS: 85-60-9 and is commercially available under the name Songnox™ 4425 from Songwon Industrial Group (South Korea).

Compound (11) is classified as CAS: 23128-74 and is commercially available under the name Songnox™ 1098 from Songwon Industrial Group (South Korea).

Compound (12) is classified as CAS: 36443-68-2 and is commercially available under the name Irganox™ 245 from BASF (Germany).

In addition, the stabilizer solution may optionally contain a sulfur-containing antioxidant. Mixtures of two or more such components may also be used.

A sulfur-containing antioxidant may for example have a structure corresponding to R₁—CH₂—(S)ₓ—CH₂—R₂, where x=1 or 2 and where R₁ and R₂ may be identical or different and represent aromatic or aliphatic groups. R₁ and R₂ are preferably aliphatic groups that may be linear or branched and may contain functional groups.

Examples of commercially available sulfur-containing antioxidants are dilauryl 3,3′-thiodipropionate (CAS 123-28-4), distearyl 3,3′-thiodipropionate (CAS 693-36-7), ditridecyl thiodipropionate (CAS 10595-72-9); pentaerythritol tetrakis (β-laurylthiopropionate) (CAS 29598-76-3), 2,2′-thiodiethylenebis [3-(3,5-di-t-butyl-4-hydroxyphenyl) propionate] (CAS 41484-35-9), dimyristyl thiodipropionate (CAS 16545-54-3) and distearyl disulfide (CAS 2500-88-1) and mixtures of these substances.

Alternatively, the sulfur-containing antioxidant may also include one or more diphenyl thioesters, for example 4,4′-thiobis(2-t-butyl-5-methylphenol) (CAS 96-69-5) and 2,2′-thiobis(6-t-butyl-4-methylphenol) (CAS 90-66-4).

A particularly preferred sulfur-containing antioxidant is pentaerythritol tetrakis(β-laurylthiopropionate) (CAS 29598-76-3) (structure (13)).

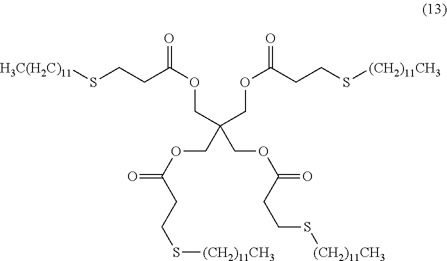

It is further preferable that the thermoplastic polyurethane powder comprises, after the abovementioned impregnation, 0.005% to 2.0% by weight of the stabilizer from the stabilizer solution, based on the total weight of the thermoplastic polyurethane powder. The thermoplastic polyurethane powder obtained after impregnation preferably has a b value of ≤4.0, further preferably of from 0.1 to 2.5, determined in the CIELab colour space using a spectrophotometer with light type D65 at 8° in accordance with DIN EN ISO 11664-4. In addition, it is preferable that, after exposure to a temperature of 120° C. for a period of 96 h and/or of 155° C. for a period of 6 h, in each case under an air atmosphere, the thermoplastic polyurethane powder exhibits a change in b value (Δb) of ≤3.5, preferably of from 0.1 to 2.8, further preferably from 0.2 to 2.0, where the b value in the CIELab colour space is determined using a spectrophotometer with light type D65 at 8° in accordance with DIN EN ISO 11664-4 and the change in b value is obtained by subtracting the b value before exposure to higher temperature from the b value after exposure to higher temperature. Specifically, it was surprisingly found that the abovementioned impregnation according to the invention resulted in a reduction in yellowing of the thermoplastic polyurethane powder, even after exposure to higher temperature, which can otherwise, as a consequence of the drying step, be very pronounced in thermoplastic polyurethane powders produced by solvent processes, especially aliphatic thermoplastic polyurethane powders (German Plastics Practice, 1946, p. 304). As explained above, the b value in the CIELab colour space is used in the context of the invention as a measure of the yellowing or “perceived whiteness” of the polyurethane powder. The CIELab colour space is made up of the L, a and the abovementioned b values. “L” defines the lightness, “a” the red/green value and “b” the yellow/blue value. To determine the b value, a colour measurement of the respective sample (an approx. 3 mm layer of powder between two microscopy cover slips) is carried out using a portable spectrophotometer (Konica Minolta CM5) using light type D65 at 8° (observer) and diffuse illumination in accordance with DIN EN ISO 11664-4. The colour of the powder is measured in reflectance mode and expressed in the CIELab colour space by the L, a and b values. The b value is calculated from the measured spectral reflectance curve using the instrument software.

The invention further relates to a thermoplastic polyurethane powder obtained or obtainable by the process of the invention. As already explained further above, these thermoplastic polyurethane powders have a high mass-average molar mass allied with a low allophanate content. If these have also been additionally impregnated in accordance with the invention, they also show less yellowing after exposure to higher temperature.

In addition, the invention relates to the use of the thermoplastic polyurethane powder of the invention in an extrusion process, injection-moulding process, powder sintering process, solvent process and/or melt process, especially for the production of mouldings and/or coatings.

The invention further relates to a moulding obtained or obtainable by processing the thermoplastic polyurethane powder of the invention. The moulding is preferably free of gel particles. Gel particles are determined by a “gel determination”. In this determination, the thermoplastic polyurethane powder is injection-moulded into a standard rod (dimensions 80 mm×10 mm×4 mm). The rod is placed on its flat side on a light table. The gel particles are visible to the naked eye in transmitted light as bright spots in the otherwise homogeneous sample. In addition, the circular depressions on the smooth surface of the test specimens produced by gel particles close to the surface are counted. To take account of minor injection moulding defects, the sample was judged to be free of gel (“free of gel particles”) if the sum total of the counted gel particles X is <5, slightly contaminated with gels if 5<X<15, highly contaminated if 15<X<30 and very highly contaminated if X>30.

### Embodiments

The invention relates in particular to the following embodiments:

In a first embodiment, the invention relates to a process for producing a thermoplastic polyurethane powder by precipitation polymerization, comprising the steps of:
i. providing
   A) a solvent mixture comprising at least one first aprotic solvent A1) having a relative permittivity εᵣ of 3 to 20 and at least one second aprotic polar solvent A2) having a relative permittivity εᵣ of at least 24, the relative permittivity εᵣ being measured in each case at 20° C. and 100 kHz;
   B) at least one polyol having a molar mass of between 60 g/mol and 250 g/mol;
   C) at least one diisocyanate;
   D) optionally a catalyst;
   E) optionally a chain regulator E1) and/or an additive E2);
ii. reacting the polyol B) with the diisocyanate C) in the solvent mixture A) at a temperature of not more than 150° C., optionally in the presence of the catalyst D), the chain regulator E1) and/or the additive E2), to give the thermoplastic polyurethane, wherein the thermoplastic polyurethane precipitates as a solid in the solvent mixture A), forming a dispersion;
iii. removing the solvent mixture and optionally washing the thermoplastic polyurethane with a solvent; and
iv. drying the thermoplastic polyurethane to give the thermoplastic polyurethane powder;
wherein the thermoplastic polyurethane powder has
   a mass-average molar mass Mw of >35 000 g/mol;
   an allophanate content of <0.25 mol % based on the total thermoplastic polyurethane powder; and
   >25.0% by weight of a particle fraction of <0.500 mm, based on the total thermoplastic polyurethane powder, and/or a ratio of centrifuge-average molar mass Mz to mass-average molar mass Mw of <4.0;
wherein the mass-average molar mass Mw, the allophanate content, the particle fraction and the centrifuge-average molar mass Mz are in each case determined using the methods described in the description.

In a second embodiment, the invention relates to a process according to the first embodiment, characterized in that the first aprotic solvent A1) comprises or consists of halogenated aromatics, ketones, ethers, esters and carbonates or mixtures thereof, especially chlorobenzene and/or ortho-dichlorobenzene, cyclopentanone, cyclohexanone, heptan-4-one, acetophenone or mixtures thereof, preferably chlorobenzene, and/or the second aprotic polar solvent A2) of dimethyl sulfoxide, dimethylformamide, N-methyl-2-pyrrolidone, tetramethylurea, 1,3-dimethyl-3,4,5,6-tetrahydro-2 (1H)-pyrimidinone, 1,3-dimethyl-2-imidazolidinone, N-ethyl-2-pyrrolidone, benzonitrile, dimethylacetamide or mixtures thereof, preferably dimethyl sulfoxide.

In a third embodiment, the invention relates to a process according to the first or second embodiment, characterized in that the ratio of the first aprotic solvent A1) to the second aprotic polar solvent A2) is 300:1 to 1:9, preferably 200:1 to 1:1, further preferably 100:1 to 8:2.

In a fourth embodiment, the invention relates to a process according to any of the preceding embodiments, characterized in that the polyol B) comprises or consists of ethylene glycol, propane-1,3-diol, butane-1,4-diol, pentane-1,5-diol, neopentyl glycol, hexane-1,6-diol, octane-1,8-diol, decane-1,10-diol, dodecane-1,12-diol or mixtures thereof, wherein the polyol B) preferably comprises at least 50.0% by weight of butane-1,4-diol, more preferably at least 90.0% by weight of butane-1,4-diol, based on the total weight of polyol B).

In a fifth embodiment, the invention relates to a process according to any of the preceding embodiments, characterized in that the diisocyanate C) comprises or consists of butane 1,4-diisocyanate, pentane 1,5-diisocyanate, hexane 1,6-diisocyanate, isophorone diisocyanate, 1,1′-methylene bis(4-isocyanatocyclohexane) or xylylene diisocyanate, especially m-xylylene diisocyanate, or mixtures thereof, wherein the diisocyanate C) preferably comprises at least 50.0% by weight of pentane 1,5-diisocyanate or hexane 1,6-diisocyanate, based on the total weight of the diisocyanate C).

In a sixth embodiment, the invention relates to a process according to any of the preceding embodiments, characterized in that
the catalyst D) is selected from the group comprising or consisting of typical urethanation catalysts such as those in Becker/Braun, Kunststoffhandbuch [Plastics Handbook], volume 7, Polyurethane [Polyurethanes], chapter 3.4, or mixtures thereof;
the chain regulator E1) is selected from the group comprising or consisting of monofunctional compounds having a hydrogen atom with Zerewitinoff acidity, monofunctional isocyanates or mixtures thereof; and/or
the additive E2) is selected from the group comprising or consisting of stabilizers, dyes and markers or mixtures thereof.

In a seventh embodiment, the invention relates to a process according to any of the preceding embodiments, characterized in that
30.0% to 95.0% by weight, preferably 60.0% to 90.0% by weight, of the solvent mixture A);
2.0% to 40.0% by weight, preferably 3.0% to 20.0% by weight, of the polyol B);
3.0% to 40.0% by weight, preferably 5.0% to 25.0% by weight, of the diisocyanate C);
0% to 5.0% by weight, preferably 0% to 0.1% by weight, of the catalyst D);
0% to 10.0% by weight, preferably 0.001% to 1.5% by weight, of the chain regulator E1);
0% to 20.0% by weight, preferably 0.0001% to 3.0% by weight, of the additive E2);
are provided, in each case based on the total amount of solvent mixture A), polyol B), diisocyanate C), catalyst D), chain regulator E1) and additive E2), normalized to 100% by weight.

In an eighth embodiment, the invention relates to a process according to any of the preceding embodiments, characterized in that the reaction in step ii. is carried out at a temperature of from 50° C. to 150° C., preferably from 100° C. to 145° C., further preferably from 120° C. to 140° C.

In a ninth embodiment, the invention relates to a process according to any of the preceding embodiments, characterized in that the reaction in step ii. is carried out at an isocyanate index of from 0.95 to 1.1, preferably 0.97 to 1.02, further preferably 0.98 to 1.0.

In a tenth embodiment, the invention relates to a process according to any of the preceding embodiments, characterized in that the dispersion formed in step ii. has a solids content of from 5.0% to 50.0% by weight, preferably from 15.0% to 45.0% by weight, further preferably from 20.0% to 40.0% by weight, determined by gravimetric measurement with and without solvent.

In an eleventh embodiment, the invention relates to a process according to any of the preceding embodiments, characterized in that the removal in step iii. is effected by filtration, centrifugation and/or by evaporation of the solvents.

In a twelfth embodiment, the invention relates to a process according to any of the preceding embodiments, characterized in that the drying in step iv. is carried out in a paddle dryer.

In a thirteenth embodiment, the invention relates to a process according to any of the preceding embodiments, characterized in that the thermoplastic polyurethane powder has
a mass-average molar mass Mw of from 40 000 to 300 000 g/mol, preferably from 45 000 to 150 000 g/mol, more preferably from 55 000 to 100 000 g/mol;
an allophanate content of from 0 to 0.20 mol %, preferably from 0.001 to 0.15 mol %, more preferably from 0.01 to 0.10 mol %, based on the total thermoplastic polyurethane powder; and/or
from 30.0% to 100.0% by weight, further preferably from 40.0% to 80.0% by weight, of a particle fraction of <0.500 mm, based on the total thermoplastic polyurethane powder, and/or a ratio of centrifuge-average molar mass Mz to mass-average molar mass Mw of <3.0, preferably of from 1.5 to 2.2.

In a fourteenth embodiment, the invention relates to a process according to any of the preceding embodiments, characterized in that the thermoplastic polyurethane according to step iii, and/or the thermoplastic polyurethane powder according to step iv. is impregnated with a stabilizer from a stabilizer solution, wherein the thermoplastic polyurethane according to step iii, and/or the thermoplastic polyurethane powder according to step iv. is, to this end, dispersed in the stabilizer solution and then separated off and dried.

In a fifteenth embodiment, the invention relates to a process according to the fourteenth embodiment, characterized in that the stabilizer solution comprises or consists of
a solvent selected from the group comprising or consisting of solvents of the group of chlorinated aromatics; aliphatics; esters; ethers; alcohols; water; ketones; nitriles; carbonates; or mixtures thereof, or preferably the solvent(s) A1) from step i., the solvent(s) preferably having a boiling point of <250° C. at 1 bar; and
a stabilizer dissolved therein selected from the group comprising or consisting of sterically hindered phenol derivatives, organic phosphine, phosphite and/or phosphonate derivatives, sulfur-containing antioxidants, 2,2,6,6-tetramethylpiperidine derivatives, benzotriazole derivatives, triazine derivatives, hydroxybenzophenone derivatives, cyanoacrylate derivatives, oxalinide derivatives or mixtures thereof;
where the proportion by weight of the stabilizer is preferably from 0.001% to 10.0% by weight, further preferably from 0.05% to 5.0% by weight, based on the total weight of the stabilizer solution.

In a sixteenth embodiment, the invention relates to a process according to the fourteenth or fifteenth embodiment, characterized in that the thermoplastic polyurethane powder comprises 0.005% to 2.0% by weight of the stabilizer from the stabilizer solution, based on the total weight of the thermoplastic polyurethane powder.

In a seventeenth embodiment, the invention relates to a process according to the fourteenth to sixteenth embodiment, characterized in that the thermoplastic polyurethane powder has a b value of ≤4.0, preferably of from 0.1 to 2.5, and/or that, after exposure to a temperature of 120° C. for a period of 96 h and/or of 155° C. for a period of 6 h, in each case under an air atmosphere, the thermoplastic polyurethane powder exhibits a change in b value of ≤3.5, preferably of from 0.1 to 2.8, further preferably from 0.2 to 2.0, where the b value in the CIELab colour space is determined using a spectrophotometer with light type D65 at 8° in accordance with DIN EN ISO 11664-4 and the change in b value is obtained by subtracting the b value before exposure to higher temperature from the b value after exposure to higher temperature.

In an eighteenth embodiment, the invention relates to a thermoplastic polyurethane powder obtained or obtainable by a process according to any of embodiments 1 to 17.

In a nineteenth embodiment, the invention relates to the use of a thermoplastic polyurethane powder according to the eighteenth embodiment in an extrusion process, injection-moulding process, powder sintering process, solvent process and/or melt process, especially for the production of mouldings and/or coatings.

In a twentieth embodiment, the invention relates to a moulding obtained or obtainable by processing a thermoplastic polyurethane powder according to the eighteenth embodiment.

In a twenty-first embodiment, the invention relates to a moulding according to the twentieth embodiment, characterized in that the moulding is free of gel particles, where “free of gel particles” is defined and determined as described in the description.

### Examples

The present invention is more particularly elucidated with reference to the following examples.

### Measurement Methods

The following measurement methods were used:

### GPC Method for Determining the Number-Average Molar Mass Mn, Mass-Average Molar Mass Mw and Centrifuge-Average Molar Mass Mz:

Determination by gel-permeation chromatography (GPC). For this, the analysis sample was dissolved in a solution of 3 g of potassium trifluoroacetate in 400 cubic centimetres of hexafluoroisopropanol (concentration of sample approx. 2 mg/cubic centimetre). The respective GPCs were measured with the following components at a flow rate of 1 cubic centimetre/minute:
Pump: 515 HPLC pump (Waters GmbH)
Detector: Smartline 2300 RI detector (Knauer Wissenschaftliche Geräte GmbH)
Columns: 1 precolumn, 1000 Å PSS PFG 7 μm, 300 Å PSS PFG 7 μm, 100 Å PSS
PFG 7 μm in this sequence (PSS Polymer Standards Service GmbH)
Degassing: PSS degasser (PSS Polymer Standards Service GmbH)
Injected volume: 100 microlitres
Temperature: 23° C.-25° C.
Molar mass standard: Polymethylmethacrylate standard kit (PSS Polymer Standards Service GmbH)

The number-average molar mass (M̅ₙ) was calculated from the data obtained by the gel-permeation chromatography measurement using the following equation:

$${\overline{M}}_{n} = \frac{{\sum }_{i} {n}_{i} {M}_{i}}{{\sum }_{i} {n}_{i}} in g / mol$$

where:
Mᵢ is the molar mass of the polymers of fraction i, such that Mᵢ<Mᵢ₊₁ for all i, in g/mol, nᵢ is the molar amount of the polymer of fraction i, in mol.

The mass-average molar mass (M̅_{w}) was likewise calculated from the data obtained by the gel-permeation chromatography measurement using the following equation:

$${\overline{M}}_{w} = \frac{{\sum }_{i} {n}_{i} {M}_{i}^{2}}{{\sum }_{i} {n}_{i} {M}_{i}} in g / mol$$

where:
Mᵢ is the molar mass of the polymers of fraction i, such that Mᵢ<Mᵢ₊₁ for all i, in g/mol,
nᵢ is the molar amount of the polymer of fraction i, in mol.

The centrifuge-average molar mass (M̅_{z}) was calculated from the data obtained by the gel-permeation chromatography measurement using the following equation:

$${\overline{M}}_{z} = \frac{{\sum }_{i} {n}_{i} {M}_{i}^{3}}{{\sum }_{i} {n}_{i} {M}_{i}^{2}} in g / mol$$

where:
Mᵢ is the molar mass of the polymers of fraction i, such that Mᵢ<Mᵢ₊₁ for all i, in g/mol,
nᵢ is the molar amount of the polymer of fraction i, in mol.

### Allophanate Content:

The allophanate content was determined by ¹H NMR. Measurements were carried out using a Bruker AV III HD 600 spectrometer at 600 MHz in DMSO-D6 at 80° C.

The following peaks were evaluated:

| | | | | |
|---|---|---|---|---|
| U= | CH₂—NH | 2.98 | ppm | CH₂ in urethane |
| O= | CH₂—OH | 3.43 | ppm | CH₂ next to OH groups |
| N= | N—H | 6.6 | ppm | urethane |
| A= | N—H | 8.3-8.4 | ppm | allophanate |

The aliphatic allophanate concentration in mol % was calculated using the following formula:

Allophanate [mol %]=100%*A/(A+N)

The conversion index is obtained from the formula:

I=1/(1+O/U)

### Colour Values:

Colour values in the CIELab colour space were determined using a Konica Minolta CM5 spectrophotometer under diffuse illumination (d/8 geometry) in accordance with DIN EN ISO 11664-4.

### Differential Scanning Calorimetry (DSC):

Melting point was determined by DSC (differential scanning calorimetry) using a DSC Q2000 V24.11 from TA Instruments according to DIN EN 61006 (November 2004). The instrument was calibrated through the melt onset temperature of indium and lead. Approx. 10 mg of substance was weighed into standard capsules. The measurement comprised two heating runs from −20° C. to +220° C. at a heating rate of 20 K/min with cooling in between at a cooling rate of 20 K/min. Cooling was with liquid nitrogen. The purge gas used was nitrogen. The first heating run erases the thermal history of the sample. The values reported are in each case based on evaluation of the first cooling curve and the second heating curve.

### Determination of Elastic Modulus and Elongation at Break:

Tensile testing was carried out on the basis of test method DIN EN ISO 527 using type 5A test specimens (DIN EN ISO 527-2, thickness 2 mm). The test specimens were stored under standard conditions for at least 24 h prior to testing. The tensile tests were carried out at 22° C. and 50% relative humidity using a Zwick Z010 universal testing machine at a speed of 10 mm/min. The elastic modulus was determined between 0.05% and 0.25% strain using the secant method.

### Isocyanate Titration:

By back-titration of butylamine with 0.1 N hydrochloric acid after addition of an excess of amine to an isocyanate solution, using a Metrohm 751 GPD Titrino, 685 Dosimat and 728 stirrer.

### Production of Test Specimens for Tensile Tests

The polymer was dried at 80° C. in a drying oven for 4 h and then processed on an Xplore MC 15 HT microextruder (15 mL) and brought into the required shape using the associated injection moulding IM 12 micro moulder.

### Gel Determination:

The respective polymer powder was injection-moulded into a standard rod (dimensions 80 mm×10 mm×4 mm). The rod was placed on its flat side on a light table. The gel particles were visible to the naked eye in transmitted light as bright spots in the otherwise homogeneous sample. In addition, the circular depressions on the smooth surface of the test specimens produced by gel particles close to the surface were counted. To take account of minor injection moulding defects, the sample was judged to be free of gel if the sum total of the counted gel particles X was <5, slightly contaminated with gels if 5<X<15, highly contaminated if 15<X<30 and very highly contaminated if X>30.

### Screening:

A 100 g amount of sample was screened for 5 min using a Haver & Boecker laboratory sieve shaker No. 7279 (build year 1978) and the corresponding screen sets (0.100 mm, 0.250 mm and 0.500 mm) and the individual fractions then weighed.

### Materials:

The following materials were used for components A) to E):

### First Aprotic Solvent A1):

Chlorobenzene, analytical grade, obtained from Azelis Deutschland GmbH, relative permittivity: εᵣ=5.6 (see reference 1.) further below)·
o-Dichlorobenzene (oDCB), 99%, obtained from Acros Organics, relative permittivity: εᵣ=9.9 (see reference 1.) further below)
Acetone, analytical grade, obtained from Merck, relative permittivity: εᵣ=21.5 (see reference 1.) further below).
Butyl acetate, obtained from Azelis Deutschland GmbH, relative permittivity: εᵣ=5.0 (see reference 1.) further below)
Isoamyl acetate, isomer mixture of 2- and 3-methylbutyl acetate, 99%, obtained from Thermo Fischer, relative permittivity: εᵣ=4.8 (see reference 1.) further below)
4-Heptanone, 98%, obtained from Thermo Fischer, relative permittivity: εᵣ=12.6 (see reference 1.) further below)
Cyclohexanone, 99.8%, obtained from Merck, relative permittivity: εᵣ=18.2 (see reference 9.) further below).
Methoxypropyl acetate, obtained from Azelis Deutschland GmbH
Xylene, obtained from Azelis Deutschland GmbH, relative permittivity: εᵣ=2.3 (see reference 1.) further below)

### Second Aprotic Polar Solvent A2):

Dimethylformamide (DMF), ≥99%, obtained from Merck, relative permittivity: εᵣ=37.6 (see reference 1.) further below)
Dimethyl sulfoxide (DMSO), 99.9%, obtained from Merck, relative permittivity: εᵣ=47.3 (see reference 2.) further below)
Dimethylacetamide (DMA), ≥99%, obtained from Merck, relative permittivity: εᵣ=38.9 (see reference 8.) further below)
Benzonitrile (PhCN), 99%, obtained from Merck, relative permittivity: εᵣ=25.6 (see reference 1.) further below)
N-Methylpyrrolidone (NMP), obtained from Azelis Deutschland GmbH, relative permittivity: εᵣ=32.5 (see reference 3.) further below)
Tetramethylurea (TMU), 99%, obtained from Merck, relative permittivity: εᵣ=24.5 (see reference 6.) further below)
1,3-Dimethyl-2-imidazolidinone, >99.5%, obtained from Merck, relative permittivity: εᵣ=37.6 (see reference 7.) further below)
Propylene carbonate, 99%, obtained from Merck, relative permittivity: εᵣ=65 (see reference 5.) further below)
Gamma-butyrolactone, >99%, obtained from TCI, relative permittivity: εᵣ=42.3 (see reference 4.) further below)

References: 1.) DK Handbook, Endress+Hauser Messtechnik Gmbh & Co. (1999); 2.) Hunger et al. J. Chem. Eng. Data 2010, 55, 5, 2055-2065; 3.) Granzhan et al, Zh. Prikl. Khim. 43 (1970) 1875-1877; 4.) MouMouzias et al. J. Chem. Eng. Data 1999, 44, 6, 1273-1278; 5.) Barthel et al. J. Chem. Eng. Data 2000, 45, 6, 1007-1011; 6.) Data from NIST Standard Reference Database 69: NIST Chemistry WebBook; 7.) Volume 17 “Static Dielectric Constants of Pure Liquids and Binary Liquid Mixtures (Supplement to IV/6)” of Landolt-Bornstein Group IV “Physical Chemistry”; 8.) Dielectric Constant of Common solvents.xls (washington.edu); 9.) Reference values for dielectric constants of Magtech products|Emerson DE

### Polyol B):

Ethylene glycol (EG)
Butane-1,4-diol (BDO) (from Ashland), purity: ≥99% by weight;

### Diisocyanate C):

Hexamethylene 1,6-diisocyanate (HDI) (from Covestro AG), purity: ≥99% by weight;
Pentamethylene 1,5-diisocyanate (PDI) (from Covestro AG), purity: ≥99% by weight;
4,4′-Methylene diphenyl isocyanate (MDI) (from Covestro AG), purity: ≥99% by weight.
   Chain regulator E1):
n-Octanol, analytical grade, obtained from Arcos Organics, purity: ≥99% by weight.

### Additive E2):

Irganox™ 245 from BASF.
Irgafos™ 168 from BASF

### Experimental Procedure and Results

### Experiment 1: HDI and BDO in Chlorobenzene (Solvent A1) and Various Solvents A2 (Hereinafter Also Referred to as Cosolvents)

A 2 L reaction vessel with thermometer, reflux condenser and mechanical stirrer was filled at 20° C. with 1200 ml of a 10:1 mixture of chlorobenzene and cosolvent, 100.9 g (1.12 mol) of BDO, 1.43 g (11 mmol) of n-octanol and 94.9 g (0.565 mol) of HDI. The mixture was slowly heated to reflux on an oil bath and a further 94.9 g (0.565 mol) of HDI was added from a dropping funnel with stirring, such that the mixture boiled gently under reflux. At the end of the addition, the mixture was heated under reflux for a further 5 hours. The polymer precipitated as a white powder. The mixture was cooled to 20° C. and filtered (suction filter) and the solid residue washed with two 150 mL portions of chlorobenzene and two 150 mL portions of acetone. The white solid was dried first in air and then under reduced pressure at 120° C. until constant weight. In the NMR spectrum, no allophanate was found in the examples according to the invention. The injection mouldings showed no gel particles. The product was then separated into 4 particle fractions by vibration screening using the 0.100 mm, 0.250 mm and 0.500 mm screen inserts. The results are summarized in Table 1:

TABLE 1

| | | | Proportion in % | | | |
|---|---|---|---|---|---|---|
| | | | by weight | | | |
| | | | <0.100 | | | |
| | | | 0.100-0.250 | Mw [g/mol] | Elastic | Elongation |
| | | | 0.250-0.500 | Mn [g/mol] | modulus | at break |
| Experiment | Cosolvent | Yield [g] | >0.500 mm | Mz [g/mol] | [MPa] | [%] |
| 1a | — | 264 | Not determined | 27 412 | 1363 ± 53 | 69 ± 83 |
| Noninventive | | | | 7531 | | |
| | | | | 55 511 | | |
| 1b | oDCB | 277 | Not determined | 28 669 | 1981 ± 162 | 16 ± 8 |
| Noninventive | | | | 9334 | | |
| | | | | 52 012 | | |
| 1c | DMSO | 264 | 46 | 88 273 | 1267 ± 97 | 249 ± 54 |
| | | | 36 | 13 716 | | |
| | | | 8 | 181 515 | | |
| | | | 10 | | | |
| 1d | NMP | 272 | 19 | 46 307 | 1141 ± 64 | 248 ± 19 |
| | | | 68 | 9878 | | |
| | | | 4 | 90 883 | | |
| | | | 9 | | | |
| 1e | DMA | 271 | 17 | 55 841 | 1344 ± 63 | 271 ± 12 |
| | | | 42 | 10 287 | | |
| | | | 6 | 120 960 | | |
| | | | 35 | | | |
| 1f | DMF | 278 | 51 | 52 493 | 1348 ± 122 | 292 ± 18 |
| | | | 19 | 9133 | | |
| | | | 6 | 114 279 | | |
| | | | 24 | | | |
| 1g | PhCN | 267 | 14 | 45 261 | 1368 ± 399 | 262 ± 41 |
| | | | 37 | 9300 | | |
| | | | 31 | 87 209 | | |
| | | | 18 | | | |
| 1h | Tetramethylurea | 276 | 3 | 63 319 | 1921 ± 115 | 256 ± 36 |
| | | | 11 | 15 413 | | |
| | | | 23 | 114 286 | | |
| | | | 63 | | | |
| 1i | 1,3-Dimethyl-2- | 279 | 7 | 73 199 | 1655 ± 62 | 234 ± 60 |
| | imidazolidinone | | 31 | 14 297 | | |
| | | | 51 | 137 532 | | |
| | | | 11 | | | |

### Experiment 2: Variation of Ratio of Solvent A1 (Chlorobenzene) to Solvent A2 (DMSO) (According to the Invention)

A 2 L reaction vessel with thermometer, reflux condenser and mechanical stirrer was filled at 20° C. with 1200 mL of a mixture of chlorobenzene and DMSO, 198.0 g (2.2 mol) of BDO, 2.86 g (22 mmol) of n-octanol and 189.8 g (1.13 mol) of HDI. The mixture was slowly heated to reflux on an oil bath and a further 189.8 g (1.13 mol) of HDI was added from a dropping funnel with stirring, such that the mixture boiled gently under reflux. At the end of the addition, the mixture was heated under reflux for a further 5 hours. The polymer precipitated as a white powder. The mixture was cooled to 20° C. and filtered (suction filter) and the solid residue washed with two 150 mL portions of chlorobenzene and two 150 mL portions of acetone. The white solid was dried first in air and then under reduced pressure at 120° C. until constant weight. In the NMR spectrum, no allophanate was found. The injection mouldings showed no gel particles. The product was then separated into 4 particle fractions by vibration screening using the 0.100 mm, 0.250 mm and 0.500 mm screen inserts. The results are summarized in Table 2:

TABLE 2

| | | | Proportion in % | | | |
|---|---|---|---|---|---|---|
| | | | by weight | | | |
| | | | <0.100 | | | |
| | | | 0.100-0.250 | Mw [g/mol] | Elastic | |
| | MCB/DMSO | | 0.250-0.500 | Mn [g/mol] | modulus | Elongation at |
| Experiment | ratio | Yield [g] | >0.500 mm | Mz [g/mol] | [MPa] | break [%] |
| 2a | 10:1 | 529 | 25 | 60 552 | 1296 ± 83 | 276 ± 36 |
| | | | 31 | 13 396 | | |
| | | | 12 | 108 642 | | |
| | | | 22 | | | |
| 2b | 20:1 | 518 | 31 | 67 958 | 1376 ± 40 | 285 ± 20 |
| | | | 18 | 14 758 | | |
| | | | 6 | 130 907 | | |
| | | | 45 | | | |
| 2c | 40:1 | 556 | 21 | 45 560 | 1397 ± 77 | 268 ± 10 |
| | | | 27 | 10 207 | | |
| | | | 12 | 87 325 | | |
| | | | 40 | | | |
| 2d | 80:1 | 547 | 26 | 44 633 | 1629 ± 51 | 242 ± 27 |
| | | | 54 | 12 668 | | |
| | | | 4 | 80 824 | | |
| | | | 16 | | | |
| 2e | 160:1 | 550 | 22 | 39 787 | 1448 ± 107 | 252 ± 24 |
| | | | 55 | 11 519 | | |
| | | | 5 | 73 294 | | |
| | | | 18 | | | |

### Experiment 3: PDI+BDO in Chlorobenzene/DMSO (According to the Invention)

A 2 L reaction vessel with thermometer, reflux condenser and mechanical stirrer was filled at 20° C. with 1100 mL of chlorobenzene, 100 mL of DMSO, 198.0 g (2.2 mol) of BDO, 2.86 g (22 mmol) of n-octanol and 170.94 g (1.11 mol) of PDI. The mixture was slowly heated to reflux on an oil bath and a further 169.4 g (1.10 mol) of PDI was added from a dropping funnel with stirring, such that the mixture boiled gently under reflux. At the end of the addition, the mixture was heated under reflux for a further 5 hours. The polymer precipitated as a white powder. The mixture was cooled to 20° C. and filtered (suction filter) and the solid residue washed first with 800 mL of acetone and then with two 100 mL portions thereof. The white solid was dried first in air and then under reduced pressure at 120° C. until constant weight. The yield was 495 g (91%). Screening showed a proportion of 39% by weight having a particle size of less than 0.100 mm, 45% by weight having a particle size of <0.250 mm and 49% by weight having a particle size of <0.500 mm. In the NMR spectrum, no allophanate was found. GPC showed Mw: 77 491 g/mol; Mn: 12 739 g/mol; Mz: 169 409 g/mol. DSC showed a melting temperature Tm of 160° C. Tensile testing showed an elastic modulus of 993±33 MPa and an elongation at break of 340±11%. The injection mouldings showed no gel particles.

### Experiment 4: HDI/BDO/MDI in Chlorobenzene/DMSO (According to the Invention)

A 2 L reaction vessel with thermometer, reflux condenser and mechanical stirrer was filled at 20° C. with 1000 mL of chlorobenzene, 100 mL of DMSO, 100.9 g (1.12 mol) of BDO, 0.28 g (2.2 mmol) of n-octanol and 94.9 g (0.565 mol) of HDI. The mixture was slowly heated to reflux on an oil bath and a further 85.4 g (0.508 mol) of HDI was added from a dropping funnel with stirring, such that the mixture boiled gently under reflux. At the end of the HDI addition, the mixture was heated under reflux for a further 2 hours. A solution of 16.95 g (0.068 mol) of 4,4′-MDI in 100 ml of chlorobenzene was then added dropwise and the solution was heated at reflux for a further 2 hours. The mixture was cooled to room temperature with constant stirring. The polymer precipitated as a white powder. The mixture was filtered (suction filter) and the residue washed with three 250 mL portions of acetone. The white solid was dried under reduced pressure at approx. 120° C. until constant weight. The yield was 280 g (93%). Screening showed a proportion of 31% by weight having a particle size of less than 0.100 mm, 36% by weight having a particle size of <0.250 mm and 38% by weight having a particle size of <0.500 mm. In the NMR spectrum, no allophanate was found. GPC showed Mw: 155 479 g/mol; Mn: 14 144 g/mol; Mz: 476 293 g/mol. DSC showed a melting temperature Tm of 172° C. Tensile testing showed an elastic modulus of 1425±77 MPa and an elongation at break of 131±28%. The injection mouldings showed no gel particles.

### Experiment 5: HDI/EG in Chlorobenzene/DMSO (According to the Invention)

A 2 L reaction vessel with thermometer, reflux condenser and mechanical stirrer was filled at 20° C. with 1140 mL of chlorobenzene, 60 mL of DMSO, 94.79 g (1.53 mol) of ethylene glycol and 1.95 g (15 mmol) of n-octanol and the mixture was heated to reflux on an oil bath. 260.71 g (1.55 mol) of HDI was then added from a dropping funnel with stirring, such that the mixture boiled gently under reflux. At the end of the HDI addition, the mixture was heated under reflux for a further 5 hours and then cooled to room temperature. The polymer precipitates as a white powder. The mixture was filtered (suction filter) and the residue washed with three 200 mL portions of chlorobenzene. The white solid was dried in an air-circulation oven at approx. 80° C. for 24 hours. The yield was 301 g (84%). Screening showed a proportion of 0% by weight having a particle size of less than 0.100 mm, 4% by weight having a particle size of <0.250 mm and 48% by weight having a particle size of <0.500 mm. In the NMR spectrum, no allophanate was found. GPC showed Mw: 165 224 g/mol; Mn: 22 951 g/mol; Mz: 425 648 g/mol. DSC showed a melting temperature Tm of 168° C. The injection mouldings showed no gel particles.

### Experiment 6: HDI and BDO at Different T in Solvent A1 (o-Dichlorobenzene; Noninventive)

a. At 110° C.

A 250 mL reaction vessel with thermometer, reflux condenser and mechanical stirrer was filled at 20° C. with 100 mL of ortho-dichlorobenzene, 10.03 g (0.11 mol) of BDO, 0.16 g (1.25 mmol) of n-octanol and 9.49 g (0.056 mol) of HDI. The mixture was slowly heated to 110° C. on an oil bath. A further 9.49 g (0.056 mol) of HDI was then added from a dropping funnel with stirring, such that the temperature of the mixture did not exceed 110° C. At the end of the addition, the mixture was heated at 110° C. for a further 5 hours. The mixture was cooled to 20° C. with constant stirring. The polymer precipitated as a white powder. The mixture was filtered (suction filter) and the residue washed with three 100 mL portions of acetone. The white solid was then dried under reduced pressure at 80° C. until constant weight. The yield was 25.6 g (88%). In the NMR spectrum, no allophanate was found. GPC showed Mw: 16 337 g/mol; Mn: 5737 g/mol; Mz: 32 101 g/mol.

b. At 130° C.

The experiment was carried out as described under a.), but at 130° C. The yield was 25.6 g (88%). In the NMR spectrum, no allophanate was found. GPC showed Mw: 30 846 g/mol; Mn: 9721 g/mol; Mz: 59 423 g/mol. Tensile testing showed an elastic modulus of 1985±92 MPa and an elongation at break of 16±2%. The injection mouldings showed no gel particles.

c. At 150° C.

The experiment was carried out as described under a.), but at 150° C. The yield was 26.2 g (90%). In the NMR spectrum, 0.5 mol % of allophanate was found. GPC showed Mw: 254 174 g/mol; Mn: 14 363 g/mol; Mz: 3 243 653 g/mol. Tensile testing showed an elastic modulus of 1815±129 MPa and an elongation at break of 134±9%. The injection mouldings showed many (>>30) gel particles.

d. At 180° C.

The experiment was carried out as described under a.), but at 180° C. The reaction mixture initially showed visible gel formation and at the end of addition of the HDI a large lump of gel had formed on the stirrer. The product was not processed further.

### Experiment 7: HDI+BDO in Different Solvents A1 (Noninventive)

A 2 L reaction vessel with thermometer, reflux condenser and mechanical stirrer was filled at 20° C. with 1100 mL of solvent A1, 202.5 g (2.25 mol) of BDO and 190.2 g (1.13 mol) of HDI. The mixture was slowly heated to reflux or 135° C. on an oil bath. A further 190.2 g (1.13 mol) of HDI was then added from a dropping funnel with stirring, such that the mixture boiled gently under reflux (or such that the temperature did not exceed 135° C.). At the end of the addition, the mixture was heated at reflux (or at 135° C.) for a further 2 hours. The polymer precipitated as a white powder. The mixture was filtered (suction filter) and the residue washed with two 150 mL portions of acetone. The white solid was then dried under reduced pressure at approx. 80° C. until constant weight. The results are summarized in Table 3:

TABLE 3

| | | | Allophanate | Mw [g/mol] |
|---|---|---|---|---|
| Experi- | | Yield [g]/ | content | Mn [g/mol] |
| ment | Solvent A1 | Appearance | [mol %] | Mz [g/mol] |
| 7a | Butyl acetate | 553 | 0.1 | 11 280 |
| | | white powder | | 3990 |
| | | | | 20 641 |
| 7b | Cyclohexanone | lumpy, sticky | 0.2 | 33 161 |
| | | | | 8686 |
| | | | | 57 405 |
| 7c | Methoxypropyl | 478 | 0.2 | 26 608 |
| | acetate | white powder | | 7399 |
| | | | | 53 446 |
| 7d | Xylene | lumpy | 0.2 | 33 732 |
| | | | | 9925 |
| | | | | 75 515 |
| 7e | 4-Heptanone | 471 | 0.2 | 26 279 |
| | | yellow powder | | 4389 |
| | | | | 356 694 |
| 7f | Amyl acetate | 476 | 0.2 | 27 686 |
| | | white powder | | 8159 |
| | | | | 55 113 |

### Experiment 8: HDI+BDO in Solvent A2 Propylene Carbonate (Noninventive, Since No Powder)

A 2 L reaction vessel with thermometer, reflux condenser and mechanical stirrer was filled at 20° C. with 1000 mL of propylene carbonate, 178.2 g (1.98 mol) of BDO, 2.60 g (20 mmol) of n-octanol and 168.0 g (1.00 mol) of HDI and the mixture was heated to 135° C. on an oil bath. A further 168.0 g (1.00 mol) of HDI was then added dropwise from a dropping funnel with stirring, such that the internal temperature of the mixture did not exceed 135° C. At the end of the addition, the mixture was heated at 135° C. for a further 5 hours, wherein the polymer started to precipitate. The reaction mixture was cooled, the solid filtered off (suction filter) and the residue washed with three 250 mL portions of propylene carbonate. The filter cake was then dried at 120° C. under reduced pressure. The yield was 480 g (92%) as a large white lump. Screening showed a fines fraction having a particle size of <0.500 mm in a content of less than 5% by weight. In the NMR spectrum, 0.2 mol % of allophanate was found. GPC showed Mw: 85 606 g/mol; Mn: 17 210 g/mol; Mz: 189 611 g/mol.

### Experiment 9: HDI+BDO in Solvent A2 γ-Butyrolactone (Noninventive, Since No Powder)

A 2 L reaction vessel with thermometer, reflux condenser and mechanical stirrer was filled at 20° C. with 1000 mL of gamma-butyrolactone, 178.2 g (1.98 mol) of BDO, 2.60 g (20 mmol) of n-octanol and 168.0 g (1.00 mol) of HDI. The mixture was then heated to 135° C. on an oil bath. A further 168.0 g (1.00 mol) of HDI was then added from a dropping funnel with stirring at a rate such that the mixture was maintained at approx. 135° C. At the end of the addition, the mixture was heated at 135° C. for a further 5 hours. The mixture was cooled, wherein the polymer precipitated as a large lump suspended from the stirrer. A small portion of the polymer lump was removed, washed with acetone and dried so as to perform the GPC and NMR measurements. In the NMR spectrum, 0.1 mol % of allophanate was found. GPC showed Mw: 137 707 g/mol; Mn: 23 203 g/mol; Mz: 295 338 g/mol.

### Experiment 10: Thermostabilization of TPU Powder (According to the Invention)

A 2 L reaction vessel with thermometer, reflux condenser and mechanical stirrer was filled at 20° C. with 950 mL of chlorobenzene, 47.5 mL of DMSO, 191.71 g (2.13 mol) of BDO, 2.72 g (21 mmol) of n-octanol and 180.3 g (1.07 mol) of HDI. The mixture was slowly heated to reflux on an oil bath and a further 180.32 g (1.07 mol) of HDI was slowly added from a dropping funnel with stirring, such that the mixture boiled gently under reflux. At the end of the addition, the mixture was heated under reflux for a further 5 hours. The mixture was cooled to room temperature with constant stirring, wherein the polymer precipitated as a white powder. The solid was filtered off and the residue on the suction filter washed with two 250 mL portions of chlorobenzene. The solid was then suspended in a solution of 1.52 g of Irgafos 168 and 1.52 g of Irganox 245 in 250 ml of chlorobenzene for 10 minutes and filtered off. The damp filter cake was first predried at room temperature for 24 hours, then dried for 3 hours at 50° C. and, after that, according to the times in Table 4.

### Experiment 11: Comparative Example of Non-Thermostabilized TPU Powder (Noninventive)

The experiment was carried out in analogous manner to experiment 10. However, no Irgafos 168 or Irganox 245 was added in the final wash step (see Table 4).

### Experiment 12: Stabilizer Added During the Reaction (Noninventive)

The experiment was carried out in analogous manner to experiment 10, but with Irgafos 168 and Irganox 245 added immediately at the start of the reaction and not in the final wash step (see Table 4).

### Experiment 13: Stabilizer Mixed in Dry (Noninventive)

A 2 L reaction vessel with thermometer, reflux condenser and mechanical stirrer was filled at 20° C. with 950 mL of chlorobenzene, 47.5 mL of DMSO, 191.71 g (2.13 mol) of BDO, 2.72 g (21 mmol) of n-octanol and 180.3 g (1.07 mol) of HDI. The mixture was slowly heated to reflux on an oil bath and a further 180.32 g (1.07 mol) of HDI was slowly added from a dropping funnel with stirring, such that the mixture boiled gently under reflux. At the end of the addition, the mixture was heated under reflux for a further 5 hours. The mixture was cooled to room temperature with constant stirring, wherein the polymer precipitated as a white powder. The solid was filtered off and the residue on the suction filter washed with two 250 mL portions of chlorobenzene. The damp filter cake was predried first at room temperature and then for 3 hours at 50° C. The white polymer powder was mixed dry with a powdered 1.52 g of Irgafos 168 and 1.52 g of Irganox 245 and then dried according to the times in Table 4.

### Experiment 14: Comparative Example PA12 (Noninventive)

Commercially available PA12 powder (from Farsoon, FS3300PA) was stored in an air-circulation oven at 155° C. for 2 hours and for 5 hours. The yellow value b of the samples and of the untreated new material was then measured. The results are summarized in Table 4.

### Experiment 15: Comparative Example PA12 with Stabilizer (Noninventive)

To 20 g of powdered PA12 (from Farsoon, FS330PA) were added 0.06 g of Irganox 245 and 0.06 g of Irgafos 168. The mixture was mixed with 150 mL of acetone and stirred for 30 minutes. The solvent was then removed on a rotary evaporator at 40° C. and approx. 150 mbar and the powder then stored in an air-circulation oven at 155° C. for 2 hours and for 5 hours. The yellow value b of the samples and of the untreated new material was then measured. The results are summarized in Table 4.

TABLE 4

| | Additive | Temperature | Time | | | | | |
|---|---|---|---|---|---|---|---|---|
| Experiment | E2 | [° C.] | [h] | L | a | b | Δb | Comment |
| 11a | no | 20 | 0 | 97.6 | −0.2 | 0.4 | 0.0 | reference |
| 11b | no | 80 | 96 | 97.4 | −0.2 | 0.6 | 0.2 | |
| 11c | no | 100 | 96 | 97.5 | −0.5 | 1.8 | 1.4 | |
| 11d | no | 120 | 96 | 96.5 | −0.6 | 5.6 | 5.2 | |
| 10a | yes | 20 | 0 | 97.5 | −0.3 | 1.1 | 0.0 | reference |
| 10b | yes | 120 | 96 | 97.3 | −0.4 | 2.2 | 1.1 | impregnated |
| 10c | yes | 155 | 2 | 97.6 | −0.3 | 2.0 | 0.9 | impregnated |
| 10d | yes | 155 | 6 | 96.9 | −0.2 | 2.6 | 1.5 | impregnated |
| 12a | yes | 20 | 0 | 98.2 | −0.3 | 1.1 | 0 | reference |
| 12b | yes | 155 | 2 | 97.4 | −0.7 | 4.4 | 3.3 | added during |
| | | | | | | | | reaction |
| 12c | yes | 155 | 6 | 91.2 | −1.2 | 14 | 12.9 | added during |
| | | | | | | | | reaction |
| 13a | yes | 20 | 0 | 97.1 | 0 | 0.8 | 0 | reference |
| 13b | yes | 155 | 2 | 96.5 | −0.1 | 3.6 | 2.8 | mixed dry |
| 13c | yes | 155 | 6 | 96.2 | 0 | 4.5 | 3.7 | mixed dry |
| PA12 | | | | | | | | |
| 14a | no | 20 | 0 | 97.7 | −0.4 | 2.5 | 0 | reference |
| 14b | no | 155 | 2 | 94.7 | 0.5 | 7.3 | 4.8 | |
| 14c | no | 155 | 6 | 94.5 | 0.3 | 8.2 | 5.7 | |
| 15a | yes | 20 | 0 | 96.8 | 0.2 | 3.2 | 0 | reference |
| 15b | yes | 155 | 6 | 93.5 | 0.3 | 10 | 6.8 | impregnated |

### DISCUSSION

The replication of patents in experiments 1a) (DE728981C) and 1b) (German Plastics Practice 1947, 289) using chlorobenzene or a mixture of chlorobenzene/o-dichlorobenzene and the further experiments 7a) to 7f) using a solvent from group A1 resulted in thermoplastic polyurethanes, but these did not achieve the molar mass Mw of >35 000 g/mol necessary in order for the polymer to exhibit practically usable mechanical properties. For instance, mouldings made of these materials were very brittle. This was confirmed by testing the fracture behaviour (experiments 1a and b). Moreover, some of the polymers obtained did not precipitate as powders, but instead formed sticky or gel-like lumps (experiments 7b) and 7d)) that could not be readily processed, and are not producible on an industrial scale. Of the solvents in this group A1 that were tested, chlorobenzene, o-dichlorobenzene, butyl acetate and amyl acetate were found to be the most suitable, since the polyurethanes precipitated as white powders, with the polymers produced in chlorobenzene and dichlorobenzene exhibiting the highest molar mass in the group.

Attempts to improve the solubility of the polyurethane in these solvents by employing a higher temperature and so achieve higher molar masses Mw and the desired polyurethane powders of the invention (experiments 6a) to 6d)) were unsuccessful. Although the molecular weight was increased slightly at 140° C. and above the elevated temperature resulted in an increase in the allophanate content and thus to branching in the polymer. At 150° C. the allophanate content was so high that numerous gel particles were observed and at 180° C. the polymer precipitated as a single large lump.

The use of solvents A2 on their own likewise did not result in the polyurethane powders of the invention. Both experiment 8) with propylene carbonate and experiment 9) with y-butyrolactone afforded polymers having a high molecular weight Mw, which were expected to have good mechanical properties too. However, in both cases the polymer precipitated on cooling as a large lump that is processible only with difficulty, especially on an industrial scale, and does not constitute a powder for the purposes of the invention.

Only the use of a combination of solvents A1) and A2) afforded the desired thermoplastic polyurethanes in powder form and having the molecular weight of over 35 000 g/mol that is necessary for good elongation and toughness. Chlorobenzene was chosen as the solvent A1) here, since it has a boiling point in the desired temperature range, which means that the dissipation of heat from the strongly exothermic urethane reaction can be accomplished simply and pressure-free through evaporative cooling. Moreover, chlorobenzene has high reactive stability and compatibility and is also miscible with the solvents A2). Experiments 1c) to 1i) show further possible variants for the solvent A2), with the use of DMSO in particular achieving very good results. Moreover, DMSO is from the point of view of hazard classifications (see safety data sheet) preferable to the other solvents of group A2) that were used.

In experiments 2a) to 2e), the ratio of solvent A1) (chlorobenzene) and solvent A2) (DMSO) was varied over a wider range. These experiments showed that the polyurethane from HDI and BDO was always obtained as the powder of the invention and that different molecular weights Mw could be set in a controlled manner according to the mixing ratio. Thus, it is possible to selectively produce polymers having different molar masses, i.e. having varying melt viscosities, for a wide variety of processing methods.

Experiments 3), 4) and 5) show variations of the process of the invention in which different isocyanates and polyols and combinations thereof were used, and show that a wide range of polyurethane powders is obtainable with the process.

As already described by J.M. DeBell (German Plastics Practice 1947, p. 304), the TPU powders produced by precipitation processes have a tendency to readily undergo yellowing at elevated temperatures. This therefore necessitated a protracted drying process at low temperatures and also resulted in a higher residual solvent content. In addition, the yellowing to some degree prevents the use of powders in sintering processes in which the powder is exposed to high temperatures for long periods.

The tendency to yellowing was confirmed in experiments 11b), 11c) and 11d). At temperatures above 100° C. in particular, the tendency to yellowing increases sharply. Drying or storage under reduced pressure (100 mbar) likewise resulted in yellowing, presumably due to oxidation processes, since traces of oxygen cannot be completely excluded for long periods of time. This could be a consequence of the high surface area of the precipitated powders, given that this behaviour has not been observed in the melt even at much higher temperatures (O. Bayer Angew. Chem. 1947, 59, 9, 257-288). In-situ addition of known thermal stabilizers (WO2022128170, WO2022128172) during the synthesis of the polyurethane powder did not bring any significant improvement in yellowing (experiments 12b and 12c)). A marked improvement could be achieved by dry blending the TPU powder with the powdered thermal stabilizers (experiments 13b) and 13c)). However, the improvement is not yet sufficient to ensure subsequent use in all processing operations. Moreover, dry blending does not solve the problem of the protracted drying step of the TPU powder. Only the addition of the thermal stabilizers as a solution in the final wash step resulted in a TPU powder that could be dried and stored even for relatively long periods at elevated temperatures (experiments 10b) to 10d)). The mechanism of action here is not fully understood, especially since a comparison with PA 12 powder, which is likewise used for powder coating processes, for example, and has a tendency to yellowing (experiments 14a) to 14c)), showed no improvement after a similar addition of thermal stabilizers (experiments 15)).

1. A process for producing a thermoplastic polyurethane powder by precipitation polymerization, comprising the steps of:
i. providing
A) a solvent mixture comprising at least one first aprotic solvent A1) having a relative permittivity εᵣ of 3 to 20 and at least one second aprotic polar solvent A2) having a relative permittivity εᵣ of at least 24, the relative permittivity εᵣ being measured in each case at 20° C. and 100 kHz;
B) at least one polyol having a molar mass of between 60 g/mol and 250 g/mol;
C) at least one diisocyanate;
D) optionally a catalyst;
E) optionally a chain regulator E1) and/or an additive E2);
ii. reacting the polyol B) with the diisocyanate C) in the solvent mixture A) at a temperature of not more than 150° C., optionally in the presence of the catalyst D), the chain regulator E1) and/or the additive E2), to give the thermoplastic polyurethane, wherein the thermoplastic polyurethane precipitates as a solid in the solvent mixture A), forming a dispersion;
iii. removing the solvent mixture and optionally washing the thermoplastic polyurethane with a solvent; and
iv. drying the thermoplastic polyurethane to give the thermoplastic polyurethane powder;
wherein the thermoplastic polyurethane powder has
a mass-average molar mass Mw of >35 000 g/mol;
an allophanate content of <0.25 mol % based on the total thermoplastic polyurethane powder; and
25.0% by weight of a particle fraction of <0.500 mm, based on the total thermoplastic polyurethane powder, and/or a ratio of centrifuge-average molar mass Mz to mass-average molar mass Mw of <4.0.

2. The process according to claim 1, wherein the first aprotic solvent A1) comprises or consists of halogenated aromatics, ketones, ethers, esters and carbonates or mixtures thereof, and/or the second aprotic polar solvent A2) of dimethyl sulfoxide, dimethylformamide, N-methyl-2-pyrrolidone, tetramethylurea, 1,3-dimethyl-3,4,5,6-tetrahydro-2(1H)-pyrimidinone, 1,3-dimethyl-2-imidazolidinone, N-ethyl-2-pyrrolidone, benzonitrile, dimethylacetamide or mixtures thereof.

3. The process according to claim 1, wherein the ratio of the first aprotic solvent A1) to the second aprotic polar solvent A2) is 300:1 to 1:9.

4. The process according to claim 1, wherein the polyol B) comprises or consists of ethylene glycol, propane-1,3-diol, butane-1,4-diol, pentane-1,5-diol, neopentyl glycol, hexane-1,6-diol, octane-1,8-diol, decane-1,10-diol, dodecane-1,12-diol or mixtures thereof, and/or the diisocyanate C) comprises or consists of butane 1,4-diisocyanate, pentane 1,5-diisocyanate, hexane 1,6-diisocyanate, isophorone diisocyanate, 1,1′-methylene bis(4-isocyanatocyclohexane) or xylylene diisocyanate, especially m-xylylene diisocyanate, or mixtures thereof.

5. The process according to claim 1, wherein the reaction in step ii is carried out at a temperature of from 50° C. to 150° C., and/or at an isocyanate index of from 0.95 to 1.1.

6. The process according to claim 1, wherein the dispersion formed in step ii has a solids content of from 5.0% to 50.0% by weight, determined by gravimetric measurement with and without solvent.

7. The process according to claim 1, wherein the thermoplastic polyurethane powder has
a mass-average molar mass Mw of from 40 000 to 300 000 g/mol;
an allophanate content of from 0 to 0.20 mol %, based on the total thermoplastic polyurethane powder; and/or
from 30.0% to 100.0% by weight, of a particle fraction of <0.500 mm, based on the total thermoplastic polyurethane powder, and/or a ratio of centrifuge-average molar mass Mz to mass-average molar mass Mw of <3.0.

8. The process according to claim 1, wherein the thermoplastic polyurethane according to step iii and/or the thermoplastic polyurethane powder according to step iv is impregnated with a stabilizer from a stabilizer solution, wherein the thermoplastic polyurethane according to step iii and/or the thermoplastic polyurethane powder according to step iv is, to this end, dispersed in the stabilizer solution and then separated off and dried.

9. The process according to claim 8, wherein the stabilizer solution comprises or consists of
a solvent selected from the group comprising or consisting of solvents of the group of chlorinated aromatics; aliphatics; esters; ethers; alcohols; water; ketones; nitriles; carbonates; or mixtures thereof, and
a stabilizer dissolved therein selected from the group comprising or consisting of sterically hindered phenol derivatives, organic phosphine, phosphite and/or phosphonate derivatives, sulfur-containing antioxidants, 2,2,6,6-tetramethylpiperidine derivatives, benzotriazole derivatives, triazine derivatives, hydroxybenzophenone derivatives, cyanoacrylate derivatives, oxalinide derivatives or mixtures thereof;
where the proportion by weight of the stabilizer is from 0.001% to 10.0% by weight, based on the total weight of the stabilizer solution.

10. The process according to claim 8, wherein the thermoplastic polyurethane powder comprises 0.005% to 2.0% by weight of the stabilizer from the stabilizer solution, based on the total weight of the thermoplastic polyurethane powder.

11. The process according to claim 8, wherein, after exposure to a temperature of 120° C. for a period of 96 h and/or of 155° C. for a period of 6 h, in each case under an air atmosphere, the thermoplastic polyurethane powder exhibits a change in b value of ≤3.5, where the b value in the CIELab colour space is determined using a spectrophotometer with light type D65 at 8° in accordance with DIN EN ISO 11664-4 and the change in b value is obtained by subtracting the b value before exposure to higher temperature from the b value after exposure to higher temperature.

12. A thermoplastic polyurethane powder obtained or obtainable by a process according to claim 1.

13. A method for producing mouldings and/or coatings comprising providing a thermoplastic polyurethane powder according to claim 12 in an extrusion process, injection-moulding process, powder sintering process, solvent process and/or melt process.

14. A moulding obtained or obtainable by processing a thermoplastic polyurethane powder according to claim 12.

15. The moulding according to claim 14, wherein the moulding is free of gel particles.
